(19) United States
(12) Patent Application Publication
(10) Pub. No.: US 2012/0318884 A1
(43) Pub. Date: Dec. 20, 2012

(54) ELECTROSTATIC IMPINGEMENT PLATE ATOMIZER APPARATUS AND METHOD

(76) Inventors: Stephen A. McCormick, Warrington, PA (US); Michael D. Newman, Hillsborough, NJ (US)

(21) Appl. No.: 13/163,976

(22) Filed: Jun. 20, 2011

(51) Int. Cl. B05B 5/025

(52) U.S. Cl. 239/3; 239/690

(57) ABSTRACT

An impingement plate atomizer apparatus includes an electrostatically charged longitudinal member having an upper surface sized and shaped to receive a liquid cryogen thereon, a lower surface opposite to the upper surface, and at least one hole extending through the longitudinal member; an ultrasonic transducer in contact with the longitudinal member for providing ultrasonic energy thereto for atomizing the liquid cryogen into an electrostatically charged cryogen fog. A method is also provided for providing an electrostatically charged cryogen fog.

### BACKGROUND

The present embodiments relate to freezer apparatus used to cause heat transfer to objects, such as for example food products, by the application of a cryogen to same.

In a cryogenic food freezing system, nitrogen liquid, for example, is sprayed into the freezing chamber to provide refrigeration for the process. It is desirable to spray the liquid nitrogen onto the warm surface of the incoming food product so that a phase change (heat of vaporization) occurs on the surface of the food product. This evaporative cooling effect creates extremely high heat transfer coefficients. Until now, it has been very difficult if not impossible to direct a high portion of the liquid spray onto the food product, as the spray is injected through nozzles that are positioned in a freezing chamber above a belt upon which the products travel for processing. Although a portion of the liquid nitrogen is deposited onto the surface of the product, another portion of the nitrogen travels to and through the belt without contacting the product. This results in an inefficient use of the liquid cryogen.

### BRIEF DESCRIPTION OF THE DRAWINGS

For a more complete understanding of the present inventive embodiments, reference may be had to the following drawing figures taken in conjunction with the description of the embodiments, of which:

FIG. 1 shows an electrostatic impingement plate atomizer embodiment of the present invention; and

FIG. 2 shows an enlarged portion of the embodiment in FIG. 1.

### DETAILED DESCRIPTION OF THE INVENTION

As discussed below with respect to the present invention, when liquid nitrogen (N₂) is atomized, surfaces of the atomized droplets are charged by exposure to an electrostatic field. The product, such as for example a food product to be chilled or frozen, can be grounded or provided with an opposite charge which will attract the charged, atomized nitrogen droplets, allowing for a much greater proportion of the nitrogen spray being deposited onto the food product, thereby maximizing overall evaporative heat transfer at the product and use of the nitrogen.

The liquid nitrogen is disposed on an impingement plate and then atomized by an ultrasonic transducer. The impingement plate is charged such that it provides a charge directly to the atomized nitrogen gas, the charged atomized liquid nitrogen droplets are entrained directly into the flow of nitrogen gas as a fog passing through the impingement plate. This process provides more even distribution of the charged nitrogen fog and can therefore effectively replace cryogen nozzles in a freezing process.

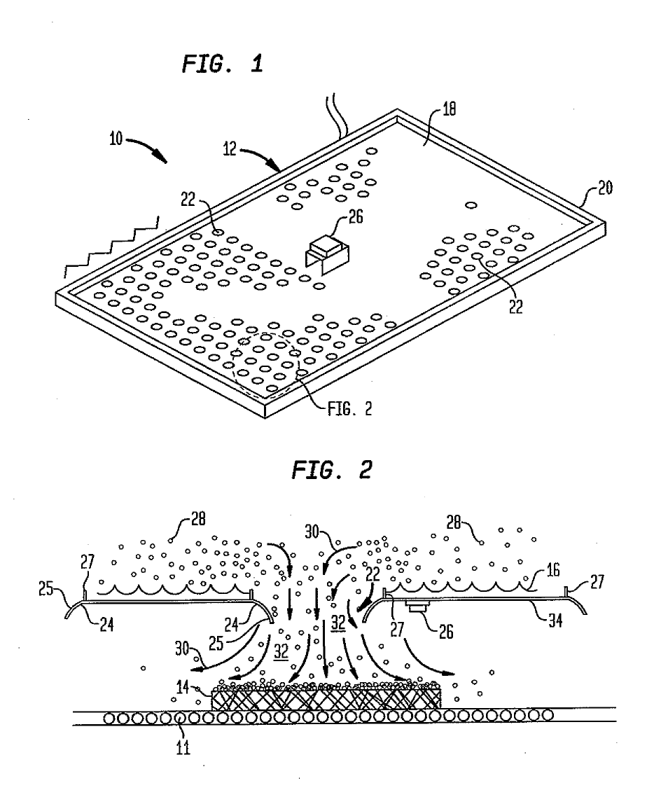

Referring to FIGS. 1 and 2, the inventive embodiment 10 includes an electrostatically charged impingement plate 12 positioned above a conveyor 11 for transporting a food product 14 to be frozen. The plate 12 can be electrostatically charged by supplying an electrical current to the plate. The charged impingement plate 12 is constructed to hold or retain a quantity of liquid cryogen, such as for example liquid nitrogen 16. This is accomplished by the plate 12 having an upper surface 18 and an edge 20 extending upward therefrom to retain a select amount of the liquid nitrogen 16 on the upper surface 18. As shown in FIG. 1, the edge 20 extends along an outer perimeter or periphery of the plate 12, but can also be constructed to extend along the plate at another area thereof where necessary to retain the liquid nitrogen.

The plate 12 is formed with at least one or a plurality of holes 22 or apertures therethrough, each one of the holes 22 having an edge 24 turned downward as shown at 25 toward the product 14 to facilitate the flow of gas as discussed below. A raised or elevated surface area 27 extends around each one of the holes 22 to prevent the liquid nitrogen 16 from pouring or seeping through the holes 22 before the nitrogen has been electrostatically charged and atomized. The raised surface area 27 functions as a dam and can be formed on the upper surface 18 by for example either pressing the plate 12 to have the upper surface 18 between the raised surface areas 27 in relief as compared to the areas 27 with same extending above the upper surface 18 as shown in FIG. 2, or by providing a wall of material to extend upward around the edges 24 of the holes 22. The raised surface area 27 may be formed integral with the plate 12. Although the holes 22 are shown having a circular shape, other shapes for the holes may be used. A nitrogen injection system (not shown) may also be provided to maintain a constant level of nitrogen on the surface 18 of the plate 12.

At least one ultrasonic transducer 26 is mounted to the upper surface 18 of the impingement plate 12. The ultrasonic transducer 26 vibrates the charged impingement plate 12 at high frequencies. The transducer 26 can also be mounted to a lower surface 34 of the impingement plate 12, as shown for example in FIG. 2. Therefore, the transducers 26 can be provided at both the upper surface 18 and/or the lower surface 34 of the impingement plate 12 to provide ultrasonic energy to the plate.

The high frequency vibration will cause the liquid nitrogen 16 disposed on the plate 12 to break-up into small atomized droplets 28. In addition, there are high velocity gas jets 30 created by a flow of nitrogen gas through the holes 22 of the impingement plate 12 by internal fans (not shown). The nitrogen droplets 28 are entrained in the gas jets 30 and forced through the holes 22. The droplets 28 become charged by direct contact with the impingement plate 12.

The droplets 28 are discharged from the impingement holes 22 and seek the closest grounded or oppositely charged object, which will be the food product 14. The food product 14 is positioned closest to the discharge at the holes 22 by being transported upon the conveyor 11, such as a belt, as shown in FIG. 2. A large portion of the charged atomized nitrogen particles adhere to the food product. The ultrasonic energy transferred to the impingement plate 12 creates the droplets 28 to be of such a small size that the entrainment of the droplets 28 in the gas jets 30 provides for a charged atomized nitrogen fog 32 to be deposited upon the food product transported on the conveyor 11. The majority of the fog 32 is deposited on the exposed surface of the food product 14, instead of being deposited on the conveyor 11 or passing through the conveyor.

The embodiment 10 can be constructed and arranged in a new freezer system, or retrofit to an existing freezer system.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. An impingement plate atomizer apparatus, comprising:
an electrostatically charged longitudinal member having an upper surface sized and shaped to receive a liquid cryogen thereon, a lower surface opposite to the upper surface, and at least one hole extending through the longitudinal member;
an ultrasonic transducer in contact with the longitudinal member for providing ultrasonic energy thereto for atomizing the liquid cryogen into an electrostatically charged cryogen fog.

2. The apparatus of claim 1, wherein the longitudinal member further comprises:
an elevated edge extending from the upper surface for retaining the liquid cryogen at the upper surface.

3. The apparatus of claim 1, wherein the longitudinal member further comprises a raised surface area extending upward from the upper surface and surrounding the at least one hole to prevent the liquid cryogen from passing through the at least one hole.

4. The apparatus of claim 1, wherein the longitudinal member further comprises a lip extending downward from the plate and around the at least one hole.

5. The apparatus of claim 1, further comprising another ultrasonic transducer in contact with the lower surface of the longitudinal member.

6. The apparatus of claim 1, further comprising a plurality of the holes extending through the longitudinal member.

7. The apparatus of claim 1, wherein the liquid cryogen comprises liquid nitrogen.

8. The apparatus of claim 1, further comprising a conveyor disposed for movement beneath the lower surface of the longitudinal member for transporting a product beneath the at least one hole for contact with the electrostatically charged cryogen fog.

9. The apparatus of claim 8, wherein the product comprises a food product.

10. The apparatus of claim 1, wherein the longitudinal member comprises a plate.

11. The apparatus of claim 1, wherein the longitudinal member is constructed from stainless steel.

12. A method of providing an electrostatically charged cryogen fog, comprising:
providing liquid cryogen to a longitudinal member;
electrostatically charging the longitudinal member;
providing ultrasonic energy to the longitudinal member for atomizing the liquid cryogen into electrostatically charged cryogen droplets;
entraining the electrostatically charged cryogen droplets in a cryogen gas flow for providing an electrostatically charged cryogen fog.

13. The method of claim 12, further comprising retaining the liquid cryogen at a surface of the longitudinal member.

14. The method of claim 12, further comprising directing the electrostatically charged cryogen fog to a product having an opposite charge.

15. The method of claim 12, wherein the liquid cryogen comprises liquid nitrogen.
